(19) United States
(12) Patent Application Publication
(10) Pub. No.: US 2011/0139328 A1
(43) Pub. Date: Jun. 16, 2011

(54) PROCESS FOR BUILDING GREEN TYRE FOR VEHICLE WHEELS AND TYRES BUILT BY SAID PROCESS

(75) Inventors: Misani Pierangelo, Milano (IT); Nahmias Nanni Marco, Milano (IT)

(73) Assignee: PIRELLI TYRE S.p.A., Milano (IT)

(21) Appl. No.: 13/058,508

(22) PCT Filed: Aug. 11, 2008
(86) PCT No.: PCT/IT2008/000547

§ 371 Date: Feb. 10, 2011

(51) Int. Cl. B60C 9/18; B29D 30/30

(52) U.S. Cl. 152/537; 156/117

(57) ABSTRACT

A process for building a green tyre for a vehicle wheel includes the steps of: a) building a carcass structure of a green tyre on a forming drum, the carcass structure including at least one carcass ply and a pair of annular anchoring structures, said at least one carcass ply being built by laying circumferentially contiguous strip-like elements; b) toroidally shaping the carcass structure for associating it to a crown structure including at least one belt structure; wherein step a) of building includes at least one step of applying a constraining layer of a green elastomeric material reinforced with fibres oriented substantially perpendicular to the axis of rotation of said forming drum, the green elastomeric material reinforced with oriented fibres exhibiting at 20% of elongation in a direction parallel to the direction of orientation of the above fibres, a strain level higher than or equal to 0.20 MPa measured according to ISO 9026 and ISO 37 standards by a specimen classified as ‘type 2’ in the ISO 37 standard.

The present invention relates to a process for building a green tyre for vehicle wheels and a tyre built by said process.

Tyre production cycles comprise firstly the carrying out of a building process wherein the various components of the tyre itself are made and/or built in one or more building lines, and subsequently the carrying out of a moulding and vulcanization process in a suitable vulcanization line, suitable for defining the tyre structure according to desired tread geometry and design.

A tyre generally comprises a toroidally ring-shaped carcass including one or more carcass plies, strengthened with reinforcing cords lying in substantially radial planes (a radial plane contains the rotation axis of the tyre). Each carcass ply has its ends integrally associated with at least one metal reinforcing annular structure, known as bead core, constituting the reinforcing at the beads, i.e. at the radially inner ends of the tyre, having the function of enabling the assembling of the tyre with a corresponding mounting rim. Placed crown wise to said carcass is a band of elastomeric material, called tread band, within which, at the end of the moulding and vulcanization steps, a raised pattern is formed for ground contact. A reinforcing structure, generally known as belt structure, is arranged between the carcass and the tread band. Such structure usually comprises, in the case of tyres for cars, at least two radially overlapped strips of rubber fabric provided with reinforcing cords, usually of metal, arranged parallel to each other in each strip and crossed with the cords of the adjacent strip, preferably symmetrical to the equatorial plane of the tyre. Preferably, the belt structure further comprises in radially outer position, at least on the ends of the underlying belt strips, also a third layer of textile or metal cords, arranged circumferentially (at 0 degrees).

Finally, in tyres of the tubeless type, a radially inner layer, called liner, is present which has imperviousness features for ensuring the air-tightness of the tyre itself.

To the aims of the present invention and in the following claims, by the term “green elastomeric material” it is intended a composition comprising at least one vulcanizable polymer base and at least one reinforcing filler. Preferably, such composition further comprises additives such as cross-linking and/or plasticizing agents. By virtue of the cross-linking agents, such material may be cross-linked by heating, so as to form the final manufactured article.

Within the scope of the present description and in the following claims, parts by weight of a given component for each 100 parts by weight of the polymer base wherein said component is dispersed shall also be referred to by the term: phr.

Within the present scope, the term “green tyre” denotes a tyre obtained by the building process and not vulcanized yet.

In the present description and in the following claims, the term “strip-like element” indicates a ribbon-like element of elastomeric material cut to size, comprising at least two textile or metal reinforcing cords.

In the present description and following claims, the term “circumferentially contiguous strip-like elements” may be understood, combined or as an alternative, as strip-like elements side by side, strip-like elements welded one to the another, strip-like elements partially overlapped in circumferential direction.

WO 04/056585 describes a pneumatic tyre for vehicle wheels comprising a toroidal carcass with a central crown portion and two axially opposite sidewalls terminating with a pair of beads for anchoring the tyre to a corresponding mounting rim, each bead comprising at least one annular reinforcing core, a tread band placed crown wise, coaxially extending around said carcass and provided with a raised pattern for rolling contact with the ground, and a belt structure coaxially interposed between said carcass and tread band, said carcass comprising at least one carcass ply, the ends of said ply extending in a radially external direction not beyond half the radial height of said annular reinforcing elements, wherein said tyre comprises at least one reinforcing layer associated to said carcass, at a radially external position relative to a point of maximum axial thickness of said carcass and at a position axially external to said belt structure. Said reinforcing layer aims to reduce the tyre deformation in the impression area for reducing the strains at the beads.

EP 1 350 616 A1 describes a tyre structural member manufacturing method that provides for forming tyre structural members from a continuous narrow strip by means of small inexpensive equipment capable of being directly combined with a tyre structural member forming machine and the relevant manufacturing system that carries out such method.

EP 1 555 113 A1 describes a method for forming a cord reinforcement layer for tyres and a cord reinforcement member-forming apparatus for carrying out the method that allow a flexible small-lot tyre production and provide tyres with high uniformity level, by coating the cords with rubber in advance and attaching the rubber-coated cords one by one onto a tyre-forming drum in its circumferential direction.

The Applicant has verified that by the tyre production methods that provide for the use of strip-like element/cord elements, such as those described in EP 1 350 616 A1 and in EP 1 555 113 A1, the finished products obtained may exhibit faults. In fact, both in the case where the strip-like elements are simply side by side and in the case where they are welded or overlapped, during the tyre shaping a problem of irregularity occurs with the arrangement of the reinforcing cords present in such strip-like elements.

In other words, during the shaping, that causes the radial expansion of the carcass ply, thinning out is created between the strip-like elements or within the same strip-like elements that make up the ply, which may cause problems of structural integrity on the finished product.

The Applicant believes that such irregularities are formed during the vulcanizing and moulding step due to the fact that the elastomeric material of the liner and/or of the under-liner is capable of penetrating in the possible thinned out areas created between the strip-like elements or therein during the shaping step.

Such problem occurs with particular criticality in the area comprised between the axially outer edges of the belt structure and the axially outermost portions of the carcass ply, due to the lack of radially outer belts that restrain the above described phenomenon.

The Applicant has therefore perceived that in order to produce finished tyres wherein such discontinuities are substantially eliminated, it is necessary to build a green tyre in such a way as to prevent the above penetration of the elastomeric material from the radially innermost layers inside the carcass ply made in strip-like elements, operating since the first steps of the green tyre building operations, that is, prior to the steps of shaping, moulding and vulcanizing the same.

Finally, the Applicant has found that by building a constraining layer in a radially inner position relative to the belt structure, said layer exhibiting suitable mechanical features of tensile strength when green, it is possible to make a barrier also in the green tyre being processed between the components of the tyre of elastomeric material and the strip-like elements that make up the carcass ply/plies, so as to prevent the penetration of different elastomeric materials between the strip-like elements themselves during the shaping step of the tyre itself, thereby preventing discontinuities on the finished product at the end of the moulding and vulcanizing steps.

According to a first aspect thereof, the invention relates to a process for building a green tyre for vehicle wheels comprising the steps of:

a) building a carcass structure of a green tyre on a forming drum, said carcass structure comprising at least one carcass ply and a pair of annular anchoring structures, said at least one carcass ply being built by laying circumferentially contiguous strip-like elements;
b) throidally shaping said carcass structure for associating it to a crown structure comprising at least one belt structure;
wherein the step a) of building comprises at least one step a1) of applying a constraining layer of a green elastomeric material reinforced with fibres oriented substantially perpendicular to the axis of rotation of said forming drum, said green elastomeric material reinforced with oriented fibres exhibiting at 20% of elongation in a direction parallel to the direction of orientation of the above fibres, a strain level higher than equal to 0.20 MPa measured according to ISO 9026 and ISO 37 standards by a specimen classified as “type 2” in said ISO 37 standard.

The Applicant believes that such barrier further serves as “belt-like” element for the carcass ply without generating thinning out between the cords of said ply even in the presence of strip-like elements making up the same carcass ply, since such belt-like element is capable of keeping, in the subsequent steps of shaping and moulding, a substantially regular density of the cords in the carcass ply.

In this way it is possible to prevent the penetration of the elastomeric material of the radially innermost layers of the tyre being processed and the thinning out of the strip-like elements making up the carcass ply of the tyre itself starting from the shaping step.

The Applicant has further checked that by building a green tyre provided with a carcass ply with strip-like elements, with a constraining layer having such mechanical features as to prevent that in the subsequent steps of shaping, vulcanizing and moulding, the mixtures of the radially innermost layers penetrate into the outermost layers, it is possible to obtain a finished product free from the structural irregularities mentioned above.

More precisely, according to a second aspect thereof, the invention relates to a green tyre for vehicle wheels comprising:
a carcass structure comprising at least one carcass ply including a plurality of circumferentially contiguous strip-like elements and a pair of annular anchoring structures;
a crown structure comprising at least one belt structure and a tread band; and
at least one constraining layer of a green elastomeric material reinforced with fibres oriented substantially perpendicular to the axis of rotation of the tyre itself in radially inner position relative to said belt structure, said green elastomeric material reinforced with fibres exhibiting at 20% of elongation in a direction parallel to the direction of orientation of the above fibres, a strain level higher than equal to 0.20 MPa measured according to ISO 9026 and ISO 37 standards by a specimen classified as “type 2” in said ISO 37 standard.

According to a third aspect thereof, the present invention relates to a process for producing a tyre for vehicle wheels comprising the step of moulding and vulcanizing a green tyre obtained by the above building process.

According to a further aspect thereof, the present invention relates to a tyre for vehicle wheels obtained by moulding and vulcanizing the above green tyre.

The present invention, in at least one of the above aspects thereof, can exhibit at least one of the following preferred features.

In a particularly preferred embodiment, the process for building the green tyre provides for the forming drum to be substantially cylindrical.

Preferably, said step b) of shaping is carried out by radial expansion of the forming drum.

According to a preferred embodiment, said green elastomeric material reinforced with oriented fibres exhibits, at 20% of elongation in a direction parallel to the direction of orientation of the above fibres, a strain level lower than equal to 0.60 MPa measured according to ISO 9026 and ISO 37 standards by a specimen classified as “type 2” in said ISO 37 standard.

Preferably, said green elastomeric material reinforced with oriented fibres exhibits, at 20% of elongation in a direction parallel to the direction of orientation of the above fibres, a strain level higher than equal to 0.30 MPa measured according to ISO 9026 and ISO 37 standards by a specimen classified as “type 2” in said ISO 37 standard.

Preferably, said green elastomeric material reinforced with oriented fibres exhibits, at 20% of elongation in a direction parallel to the direction of orientation of the above fibres, a strain level lower than equal to 0.45 MPa measured according to ISO 9026 and ISO 37 standards by a specimen classified as “type 2” in said ISO 37 standard.

In a further preferred embodiment, said green elastomeric material reinforced with oriented fibres exhibits, at 50% of elongation in a direction parallel to the direction of orientation of the above fibres, a strain level higher than equal to 0.30 MPa measured according to ISO 9026 and ISO 37 standards by a specimen classified as “type 2” in said ISO 37 standard.

Preferably, said green elastomeric material reinforced with oriented fibres exhibits, at 50% of elongation in a direction parallel to the direction of orientation of the above fibres, a strain level lower than equal to 0.90 MPa measured according to ISO 9026 and ISO 37 standards by a specimen classified as “type 2” in said ISO 37 standard.

Even more preferably, said green elastomeric material reinforced with oriented fibres exhibits, at 50% of elongation in a direction parallel to the direction of orientation of the above fibres, a strain level higher than equal to 0.45 MPa measured according to ISO 9026 and ISO 37 standards by a specimen classified as “type 2” in said ISO 37 standard.

Even more preferably, said green elastomeric material reinforced with oriented fibres exhibits, at 50% of elongation in a direction parallel to the direction of orientation of the above fibres, a strain level lower than equal to 0.70 MPa measured according to ISO 9026 and ISO 37 standards by a specimen classified as “type 2” in said ISO 37 standard.

According to a preferred embodiment, said step a1) comprises the application of the constraining layer at least at the area that at the end of said step b) is comprised between the axially outer edges of the belt structure and the axially outermost portions of the carcass ply.

Preferably, said green elastomeric material comprises a cross-linkable unsaturated chain polymer base and wherein said oriented fibres are dispersed in said polymer base.

Even more preferably, said oriented fibres are oriented substantially perpendicular to the development of the strip-like elements forming said at least one carcass ply. This is possible in the case of tyres provided with a single carcass ply and, in that case, said orientation of the fibres is particularly advantageous to ensure evenness in the arrangement of the reinforcing cords present in said strip-like elements.

Preferably, said oriented fibres comprise fibrillated aramidic fibres in an amount higher than or equal to 0.5 phr.

Even more preferably, said oriented fibres comprise fibrillated aramidic fibres in an amount higher than or equal to 2 phr.

According to a further embodiment, said oriented fibres comprise fibrillated aramidic fibres dispersed in a polymeric matrix in an amount higher than or equal to 2.17 phr.

Preferably, said oriented fibres comprise fibrillated aramidic fibres dispersed in a polymeric matrix in an amount higher than or equal to 8.7 phr.

In a preferred embodiment, said step a1) of applying a constraining layer is carried out by winding a semi-finished product prepared and cut to size on said forming drum.

In a further preferred embodiment, said step a1) of applying a constraining layer is carried out by spiralling a continuous elongated element on said forming drum according to side by side or at least partially radially overlapped coils.

Preferably, said constraining layer is positioned at least at the area comprised between the axially outer edges of the belt structure and the axially outermost portions of the carcass ply.

Preferably, said green tyre further comprises a liner in a radially inner position relative to said at least one carcass ply.

Even more preferably, said green tyre further comprises an under-liner in a radially inner position relative to said at least one carcass ply and radially external to the liner.

According to one embodiment, said constraining layer is radially external relative to said at least one carcass ply.

According to a further embodiment, said constraining layer is radially internal relative to said at least one carcass ply.

Preferably, said constraining layer is radially internal relative to the liner.

Even more preferably, said constraining layer is radially interposed between the liner and the under-liner.

Even more preferably, said constraining layer is radially interposed between the under-liner and the carcass ply.

In a preferred embodiment, said green tyre is provided with a first and a second carcass ply, said constraining layer being radially interposed between the first and the second carcass ply.

Preferably, said liner comprises the constraining layer.

Even more preferably, said liner consists of said constraining layer.

Preferably, said under-liner comprises the constraining layer.

Even more preferably, said under-liner consists of said constraining layer.

Further features and advantages of the invention will appear more clearly from the following description of some preferred examples of processes for building a green tyre for vehicle wheels and tyres built by such processes according to the invention, made by way of an indicative non-limiting example with reference to the annexed drawings, wherein:

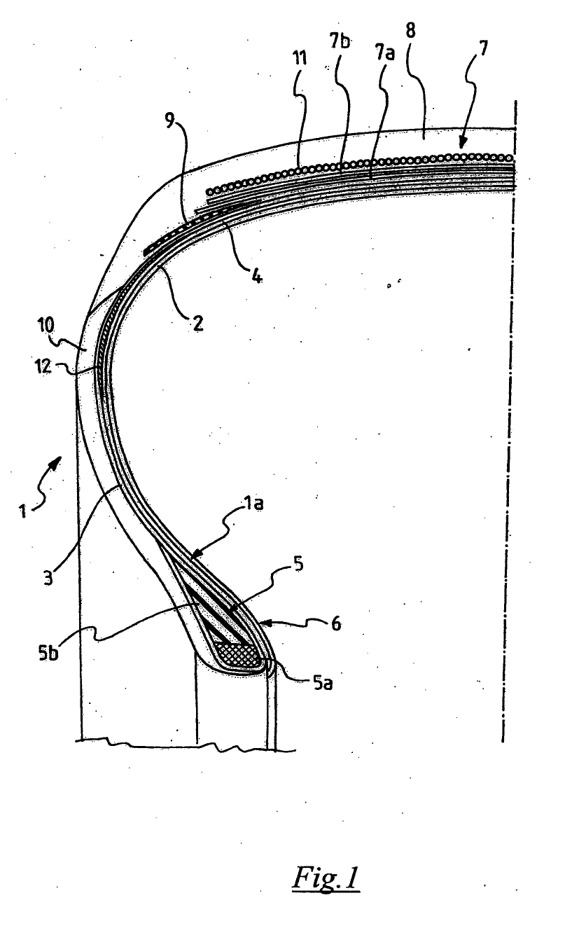

FIG. 1 shows a section view of a green tyre according to a first embodiment of the invention built by the building process according to one embodiment of the invention;

FIG. 2 shows an enlarged detail of FIG. 1;

FIG. 3 shows a section view of a green tyre according to a second embodiment of the invention built by the building process according to one embodiment of the invention;

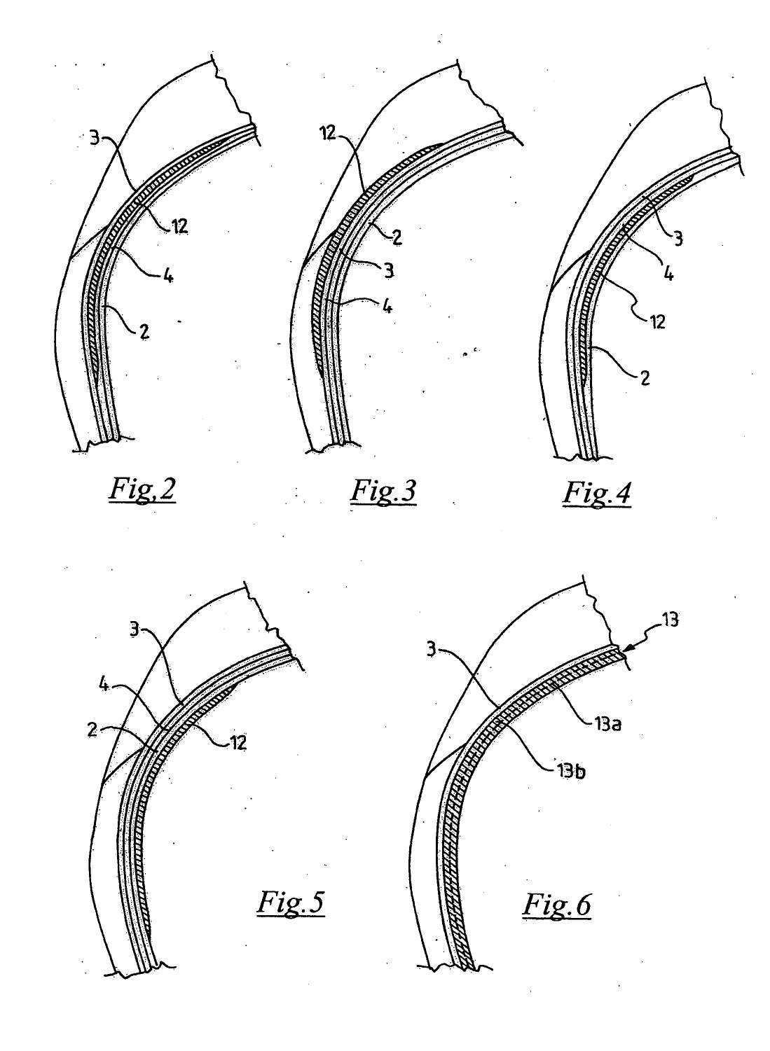

FIG. 4 shows a section view of a green tyre according to a third embodiment of the invention built by the building process according to one embodiment of the invention;

FIG. 5 shows a section view of a green tyre according to a fourth embodiment of the invention built by the building process according to one embodiment of the invention; and

FIG. 6 shows a section view of a green tyre according to a fifth embodiment of the invention built by the building process according to one embodiment of the invention.

With reference to FIG. 1, reference numeral 1 globally indicates a green tyre for vehicle wheels built by the process of the invention.

The green tyre 1 comprises a carcass structure 1a which comprises a carcass ply 3 including a plurality of circumferentially contiguous strip-like elements and a pair of annular anchoring structures 5.

The latter constitute the reinforcement of the beads, that is, of the radially inner ends of the tyre, indicated, in FIG. 1 with reference numeral 6. Each annular anchoring structure 5 comprises at least one rim 5a and one filler 5b.

In FIGS. 1-6 there is only one carcass ply, but the green tyre 1 may be built with multiple carcass plies.

The green tyre 1 further comprises a crown structure which comprises at least one belt structure 7 and a tread band 8. The belt structure 7 in turn preferably comprises two belt layers 7a, 7b, radially overlapped. Even more preferably, the belt structure 7 further comprises, in a radially outer position, also a third layer 11 of textile or metallic cords, arranged circumferentially (at 0 degrees).

Preferably, at the axial ends of the belt layers 7a and 7b there is an under-belt insert 9 and finally, in the axially outermost area of the green tyre 1, a sidewall 10.

According to the invention, the green tyre 1 further comprises at least one constraining layer 12 of a green elastomeric material reinforced with fibres oriented substantially perpendicular to the axis of rotation of the tyre itself in radially inner position relative to said belt structure 7. Said green elastomeric material reinforced with fibres exhibits at 20% of elongation in a direction parallel to the direction of orientation of the above fibres, a strain level higher than equal to 0.20 MPa measured according to ISO 9026 and ISO 37 standards by a specimen classified as “type 2” in said ISO 37 standard.

According to a preferred embodiments of the invention, said green elastomeric material reinforced with oriented fibres exhibits, at 20% of elongation in a direction parallel to the direction of orientation of the above fibres, a strain level lower than equal to 0.60 MPa measured according to ISO 9026 and ISO 37 standards by a specimen classified as “type 2” in said ISO 37 standard.

Even more preferably, said green elastomeric material reinforced with oriented fibres exhibits, at 20% of elongation in a direction parallel to the direction of orientation of the above fibres, a strain level higher than equal to 0.30 MPa and/or lower than or equal to 0.45 MPa when measured as indicated above.

According to some alternative embodiments of the invention, said green elastomeric material reinforced with oriented fibres exhibits, at 50% of elongation in a direction parallel to the direction of orientation of the above fibres, a strain level higher than equal to 0.30 MPa and/or lower than or equal to 0.90 MPa when measured as indicated above.

Preferably, said green elastomeric material reinforced with oriented fibres exhibits, at 50% of elongation in a direction parallel to the direction of orientation of the above fibres, a strain level higher than equal to 0.45 MPa and/or lower than or equal to 0.70 MPa when measured as indicated above.

The constraining layer 12 is positioned at least at the area comprised between the axially outer edges of the belt structure 7 and the axially outermost portions of the carcass ply 3, or where shown in the figures, in the tyre shoulder area. However, it may extend also from one bead 6 to the other of the green tyre 1.

According to preferred embodiments of the invention, shown in FIGS. 1-5, the green tyre 1 further comprises a liner 2 in a radially inner position relative to said at least one carcass ply 3.

According to preferred embodiments shown in the same figures, besides liner 2, tyre 1 is further provided with an under-liner 4 in a radially inner position relative to said at least one carcass ply 3 and radially outer to liner 2.

FIGS. 2 to 5 show four different embodiments of the green tyre 1 according to the invention. In all the embodiments illustrated in such figures, the green tyre 1 is provided with a liner 2, an under-liner 4, a ply 3 and a constraining layer 12, however the position of the constraining layer 12 is different in each embodiment.

In particular, in the first, third and fourth embodiment respectively shown in FIGS. 2, 4 and 5, said constraining layer 12 is radially internal relative to said at least one carcass ply 3. On the other hand, in the second embodiment, shown in FIG. 3, said constraining layer 12 is radially external relative to said at least one carcass ply 3.

More in particular, in the first embodiment shown in FIGS. 1 and 2, the constraining layer 12 is radially interposed between under-liner 4 and the carcass ply 3.

In the third embodiment shown in FIG. 4, the constraining layer 12 is radially interposed between liner 2 and the under-liner 4.

In the fourth embodiment shown in FIG. 5, the constraining layer 12 is radially internal relative to liner 2.

According to alternative embodiments of the invention not shown in the figures, the green tyre 1 is provided with a first and a second carcass ply 3 and the constraining layer 12 may also be radially interposed between the first and the second carcass ply 3, besides the positions illustrated before.

With reference to FIG. 6, it is visible that the green tyre 1 may have a different shape than that shown in the previous embodiments. In this fifth embodiment, in fact, the green tyre 1 is provided with a carcass ply 3 and with a layer 13 radially internal thereto.

Such layer 13, according to one embodiment, comprises a single liner layer comprising therein the constraining layer that may also replace the liner layer itself.

According to other embodiments, such layer 13 comprises two radially overlapped layers, liner 13a and under-liner 13b. In this case, the constraining layer may be comprised within one of said layers 13a and 13b or replace one thereof.

According to a preferred embodiment of the invention, the green elastomeric material reinforced with oriented fibres of the constraining layer comprises a cross-linkable unsaturated chain polymer base wherein reinforcing fibres are dispersed.

Such oriented fibres are oriented substantially perpendicular to the development of the strip-like elements forming said at least one carcass ply 3 and preferably comprise fibrillated aramidic fibres.

The above fibrillated aramidic fibres preferably exhibit a diameter comprised between 5 μm and 15 μm, with a length comprised between 50 μm and 500 μm.

Preferably, the amount of said fibrillated aramidic fibres is higher than or equal to 0.5 parts by weight per 100 parts by weight of polymer base (phr). More preferably, the amount of said fibrillated aramidic fibres is higher than or equal to 2 phr.

The fibrillated aramidic fibres are dispersed in a polymer matrix. For example, it is possible to use Kevlar® Engineered Elastomers 1F722 marketed by Dupont that contains 23% fibrillated aramidic fibres and 77% natural rubber.

In that case, said fibrillated aramidic fibres are dispersed in a polymeric matrix in an amount higher than or equal to 2.17 phr.

More preferably, said fibrillated aramidic fibres are dispersed in a polymeric matrix in an amount higher than or equal to 8.7 phr.

From the moulding and vulcanization of a green tyre 1 as described above it is possible to obtain a tyre with particular features of structural regularity, as explained above.

A process for building a green tyre 1 for vehicle wheels according to the present invention shall now be described.

According to a first step a), said process comprises building a carcass structure 1a of a green tyre 1 on a forming drum, said carcass structure 1a comprising at least one carcass ply 3 and a pair of annular anchoring structures 5, said at least one carcass ply 3 being built by laying circumferentially contiguous strip-like elements.

Subsequently, the process according to the invention provides for a step b) of toroidally shaping said carcass structure 1a for associating it to a crown structure comprising at least one belt structure 7.

The above building step a) according to the invention comprises, at least one step a1) of applying a constraining layer 12 of a green elastomeric material reinforced with fibres oriented substantially perpendicular to the axis of rotation of said forming drum, said green elastomeric material reinforced with oriented fibres exhibiting at 20% of elongation in a direction parallel to the direction of orientation of the above fibres, a strain level higher than equal to 0.20 MPa measured according to ISO 9026 and ISO 37 standards by a specimen classified as “type 2” in said ISO 37 standard.

The forming drum is preferably substantially cylindrical and the step b) of shaping is carried out by radial expansion of the forming drum.

According to preferred embodiments of the building process, the step a1) comprises the application of the constraining layer 12 at least at the area that at the end of the shaping step is comprised between the axially outer edges of the belt structure 7 and the axially outermost portions of the carcass ply 3, that is, where shown in FIGS. 1-5.

According to a preferred embodiment, the application of the above constraining layer 12 can be performed by winding a semi-finished product prepared and cut to size, winding it on said forming drum, either directly thereon or on top of one or more components already laid in advance (such as, for example, liner, under-liner, first carcass ply, etc.).

According to a further, more preferred embodiment, the winding of the constraining layer 12 may be carried out by spiralling a continuous elongated element by side by side or at least partially radially overlapped coils for forming said constraining layer 12. In that case, said continuous elongated element may also be produced at the time of use by extrusion.

Preferably, the oriented fibres are oriented substantially perpendicular to the development of the strip-like elements forming said at least one carcass ply.

Having the described building process followed by a moulding and vulcanization step, a tyre building process for vehicle wheels is obtained which is free from the above faults.

Within the scope of the above present description and in the following claims, all numerical values indicating amounts, parameters, percentages and so on are always to be deemed as preceded by the term “about”, if not otherwise stated. Moreover, all numerical value ranges include all possible combinations of the maximum and minimum numerical values and all possible intermediate ranges, besides those specifically indicated in the text.

1-48. (canceled)

49. A process for building a green tyre for a vehicle wheel comprising the steps of:
a) building a carcass structure of a green tyre on a forming drum, said carcass structure comprising at least one carcass ply and a pair of annular anchoring structures, said at least one carcass ply being built by laying circumferentially contiguous strip-like elements; and
b) toroidally shaping said carcass structure for associating said carcass structure to a crown structure comprising at least one belt structure, wherein step a) of building a carcass structure comprises at least one step a1) of applying a constraining layer of a green elastomeric material reinforced with fibres oriented substantially perpendicular to the axis of rotation of said forming drum, said green elastomeric material reinforced with oriented fibres exhibiting at 20% of elongation in a direction parallel to the direction of orientation of the above fibres, a strain level higher than or equal to 0.20 MPa measured according to ISO 9026 and ISO 37 standards by a specimen classified as “type 2” in said ISO 37 standard.

50. The process for building a green tyre for a vehicle wheel according to claim 49, wherein the forming drum is substantially cylindrical.

51. The process for building a green tyre for a vehicle wheel according to claim 49, wherein step b) of shaping is carried out by radial expansion of the forming drum.

52. The process for building a green tyre for a vehicle wheel according to claim 49, wherein said green elastomeric material reinforced with oriented fibres exhibits, at 20% of elongation in a direction parallel to the direction of orientation of the above fibres, a strain level lower than or equal to 0.60 MPa measured according to ISO 9026 and ISO 37 standards by a specimen classified as “type 2” in said ISO 37 standard.

53. The process for building a green tyre for a vehicle wheel according to claim 49, wherein said green elastomeric material reinforced with oriented fibres exhibits, at 20% of elongation in a direction parallel to the direction of orientation of the above fibres, a strain level higher than or equal to 0.30 MPa measured according to ISO 9026 and ISO 37 standards by a specimen classified as “type 2” in said ISO 37 standard.

54. The process for building a green tyre for a vehicle wheel according to claim 52, wherein said green elastomeric material reinforced with oriented fibres exhibits, at 20% of elongation in a direction parallel to the direction of orientation of the above fibres, a strain level lower than or equal to 0.45 MPa measured according to ISO 9026 and ISO 37 standards by a specimen classified as “type 2” in said ISO 37 standard.

55. The process for building a green tyre for a vehicle wheel according claim 49, wherein said green elastomeric material reinforced with oriented fibres exhibits, at 50% of elongation in a direction parallel to the direction of orientation of the above fibres, a strain level higher than or equal to 0.30 MPa measured according to ISO 9026 and ISO 37 standards by a specimen classified as “type 2” in said ISO 37 standard.

56. The process for building a green tyre for a vehicle wheel according claim 49, wherein said green elastomeric material reinforced with oriented fibres exhibits, at 50% of elongation in a direction parallel to the direction of orientation of the above fibres, a strain level lower than or equal to 0.90 MPa measured according to ISO 9026 and ISO 37 standards by a specimen classified as “type 2” in said ISO 37 standard.

57. The process for building a green tyre for a vehicle wheel according to claim 55, wherein said green elastomeric material reinforced with oriented fibres exhibits, at 50% of elongation in a direction parallel to the direction of orientation of the above fibres, a strain level higher than or equal to 0.45 MPa measured according to ISO 9026 and ISO 37 standards by a specimen classified as “type 2” in said ISO 37 standard.

58. The process for building a green tyre for a vehicle wheel according to claim 56, wherein said green elastomeric material reinforced with oriented fibres exhibits, at 50% of elongation in a direction parallel to the direction of orientation of the above fibres, a strain level lower than or equal to 0.70 MPa measured according to ISO 9026 and ISO 37 standards by a specimen classified as “type 2” in said ISO 37 standard.

59. The process for building a green tyre for a vehicle wheel according to claim 49, wherein step a1) comprises applying the constraining layer at least at the area that at the end of step b) is between the axially outer edges of the belt structure and the axially outermost portions of the carcass ply.

60. The process for building a green tyre for a vehicle wheel according to claim 49, wherein said green elastomeric material comprises a cross-linkable unsaturated chain polymer base and wherein said oriented fibres are dispersed in said polymer base.

61. The process for building a green tyre for a vehicle wheel according to claim 49, wherein said oriented fibres are oriented substantially perpendicular to the development of the strip-like elements forming said at least one carcass ply.

62. The process for building a green tyre for a vehicle wheel according to claim 60, wherein said oriented fibres comprise fibrillated aramidic fibres in an amount higher than or equal to 0.5 phr.

63. The process for building a green tyre for a vehicle wheel according to claim 62, wherein said oriented fibres comprise fibrillated aramidic fibres in an amount higher than or equal to 2 phr.

64. The process for building a green tyre for a vehicle wheel according to claim 60, wherein said oriented fibres comprise fibrillated aramidic fibres dispersed in a polymeric matrix in an amount higher than or equal to 2.17 phr.

65. The process for building a green tyre for a vehicle wheel according to claim 64, wherein said oriented fibres comprise fibrillated aramidic fibres dispersed in a polymeric matrix in an amount higher than or equal to 8.7 phr.

66. The process for building a green tyre for a vehicle wheel according to claim 49, wherein step a1) of applying a constraining layer is carried out by winding a semi-finished product prepared and cut to size on said forming drum.

67. The process for building a green tyre for a vehicle wheel according to claim 49, wherein step a1) of applying a constraining layer is carried out by spiralling a continuous elongated element on said forming drum according to side by side or at least partially radially overlapped coils.

68. A process for producing a tyre for a vehicle wheel comprising moulding and vulcanizing a green tyre obtained by the process according to claim 49.

69. A green tyre for a vehicle wheel comprising:
a carcass structure comprising at least one carcass ply comprising a plurality of circumferentially contiguous strip-like elements and a pair of annular anchoring structures;
a crown structure comprising at least one belt structure and a tread band; and
at least one constraining layer of a green elastomeric material reinforced with fibres oriented substantially perpendicular to an axis of rotation of the tyre in a radially inner position relative to said belt structure, said green elastomeric material reinforced with fibres exhibiting at 20% of elongation in a direction parallel to the direction of orientation of the above fibres, a strain level higher than or equal to 0.20 MPa measured according to ISO 9026 and ISO 37 standards by a specimen classified as “type 2” in said ISO 37 standard.

70. The green tyre for a vehicle wheel according to claim 69, wherein said green elastomeric material reinforced with oriented fibres exhibits, at 20% of elongation in a direction parallel to the direction of orientation of the above fibres, a strain level lower than or equal to 0.60 MPa measured according to ISO 9026 and ISO 37 standards by a specimen classified as “type 2” in said ISO 37 standard.

71. The green tyre for a vehicle wheel according to claim 69, wherein said green elastomeric material reinforced with oriented fibres exhibits, at 20% of elongation in a direction parallel to the direction of orientation of the above fibres, a strain level higher than or equal to 0.30 MPa measured according to ISO 9026 and ISO 37 standards by a specimen classified as “type 2” in said ISO 37 standard.

72. The green tyre for a vehicle wheel according to claim 70, wherein said green elastomeric material reinforced with oriented fibres exhibits, at 20% of elongation in a direction parallel to the direction of orientation of the above fibres, a strain level lower than or equal to 0.45 MPa measured according to ISO 9026 and ISO 37 standards by a specimen classified as “type 2” in said ISO 37 standard.

73. The green tyre for a vehicle wheel according to claim 69, wherein said green elastomeric material reinforced with oriented fibres exhibits, at 50% of elongation in a direction parallel to the direction of orientation of the above fibres, a strain level higher than or equal to 0.30 MPa measured according to ISO 9026 and ISO standards by a specimen classified as “type 2” in said ISO 37 standard.

74. The green tyre for a vehicle wheel according to claim 73, wherein said green elastomeric material reinforced with oriented fibres exhibits, at 50% of elongation in a direction parallel to the direction of orientation of the above fibres, a strain level lower than or equal to 0.90 MPa measured according to ISO 9026 and ISO 37 standards by a specimen classified as “type 2” in said ISO 37 standard.

75. The green tyre for a vehicle wheel according to claim 73, wherein said green elastomeric material reinforced with oriented fibres exhibits, at 50% of elongation in a direction parallel to the direction of orientation of the above fibres, a strain level higher than or equal to 0.45 MPa measured according to ISO 9026 and ISO 37 standards by a specimen classified as “type 2” in said ISO 37 standard.

76. The green tyre for a vehicle wheel according to claim 74, wherein said green elastomeric material reinforced with oriented fibres exhibits, at 50% of elongation in a direction parallel to the direction of orientation of the above fibres, a strain level lower than or equal to 0.70 MPa measured according to ISO 9026 and ISO 37 standards by a specimen classified as “type 2” in said ISO 37 standard.

77. The green tyre for a vehicle wheel according to claim 69, wherein said constraining layer is positioned at least at an area between the axially outer edges of the belt structure and the axially outermost portions of the carcass ply.

78. The green tyre for a vehicle wheel according to claim 69, further comprising a liner in a radially inner position relative to said at least one carcass ply.

79. The green tyre for a vehicle wheel according to claim 78, further comprising an under-liner in a radially inner position relative to said at least one carcass ply and radially outer to the liner.

80. The green tyre for a vehicle wheel according to claim 69, wherein said constraining layer is radially external relative to said at least one carcass ply.

81. The green tyre for a vehicle wheel according to claim 69, wherein said constraining layer is radially internal relative to said at least one carcass ply.

82. The green tyre for a vehicle wheel according to claim 81, further comprising a liner in a radially inner position relative to said at least one carcass ply, wherein said constraining layer is radially internal relative to the liner.

83. The green tyre for a vehicle wheel according to claim 81, further comprising an under-liner in a radially inner position relative to said at least one carcass ply and radially outer to a liner in a radially inner position relative to said at least one carcass ply, wherein said constraining layer is radially interposed between the liner and the under-liner.

84. The green tyre for a vehicle wheel according to claim 81, further comprising an under-liner in a radially inner position relative to said at least one carcass ply and radially outer to a liner in a radially inner position relative to said at least one carcass ply, wherein said constraining layer is radially interposed between the under-liner and the carcass ply.

85. The green tyre for a vehicle wheel according to claim 69, comprising a first and a second carcass ply, and wherein said constraining layer is radially interposed between the first and the second carcass ply.

86. The green tyre for a vehicle wheel according to claim 81, further comprising a liner in a radially inner position relative to said at least one carcass ply, wherein the liner comprises the constraining layer.

87. The green tyre for a vehicle wheel according to claim 81, further comprising a liner in a radially inner position relative to said at least one carcass ply, wherein the liner consists of said constraining layer.

88. The green tyre for a vehicle wheel according to claim 81, further comprising an under-liner in a radially inner position relative to said at least one carcass ply and radially outer to a liner in a radially inner position relative to said at least one carcass ply, wherein the under-liner comprises the constraining layer.

89. The green tyre for a vehicle wheel according to claim 81, further comprising an under-liner in a radially inner position relative to said at least one carcass ply and radially outer to a liner in a radially inner position relative to said at least one carcass ply, wherein the under-liner consists of said constraining layer.

90. The green tyre for a vehicle wheel according to claim 69, wherein the green elastomeric material reinforced with oriented fibres comprises a cross-linkable unsaturated chain polymer base wherein said reinforcing fibres are dispersed.

91. The green tyre for a vehicle wheel according to claim 69, wherein said oriented fibres are oriented substantially perpendicular to development of the strip-like elements forming said at least one carcass ply.

92. The green tyre for a vehicle wheel according to claim 90, wherein said oriented fibres comprise fibrillated aramidic fibres in an amount higher than or equal to 0.5 phr.

93. The green tyre for a vehicle wheel according to claim 92, wherein said oriented fibres comprise fibrillated aramidic fibres in an amount higher than or equal to 2 phr.

94. The green tyre for a vehicle wheel according to claim 90, wherein the oriented fibres are fibrillated aramidic fibres dispersed in a polymeric matrix in an amount higher than or equal to 2.17 phr.

95. The green tyre for a vehicle wheel according to claim 94, wherein the oriented fibres are fibrillated aramidic fibres dispersed in a polymeric matrix in an amount higher than or equal to 8.7 phr.

96. A tyre for a vehicle wheel obtained by moulding and vulcanizing a green tyre according to claim 69.
